(19) United States
(12) Patent Application Publication
(10) Pub. No.: US 2026/0189030 A1
(43) Pub. Date: Jul. 2, 2026

(54) BATTERY MANAGEMENT SYSTEM AND METHOD FOR UPDATING FIRMWARE OF SLAVE DEVICES OF BATTERY MANAGEMENT SYSTEM

(71) Applicant: Grace Connection Microelectronics Limited, Zhube City (TW)

(72) Inventors: PEI WEI CHEN, Zhubei City (TW); Chih-Hua Huang, Zhubei City (TW)

(73) Assignee: Grace Connection Microelectronics Limited, Zhubei City (TW)

(21) Appl. No.: 19/424,291

(22) Filed: Dec. 18, 2025

(30) Foreign Application Priority Data
Dec. 26, 2024 (TW) 113150933

(51) Int. Cl. H02J 7/46; H02J 7/44; H02J 7/50

(52) U.S. Cl. CPC H02J 7/46; H02J 7/44; H02J 7/50

(57) ABSTRACT

An operating method for power-saving mode of battery management system, includes: a master device transmitting a power-saving mode command to one of slave devices; the one salve devices forwarding the power-saving mode command to another slave device, and entering a deep sleep mode; the another slave device continuing to forward the power-saving mode command to yet another slave device, and to enter the deep sleep mode, such that each slave device in the predetermined forwarding order, operates sequentially to forward the power-saving mode command and to enter the deep sleep mode, until a last-stage slave device according to the predetermined forwarding order receives the power-saving mode command, and enters the deep sleep mode.

### CROSS REFERENCE

The present invention claims priority to TW113150933 filed on Dec. 26, 2024.

### BACKGROUND OF THE INVENTION

### Field of Invention

The present invention relates to a battery management system (BMS) with a wireless daisy chain network topology, and more particularly to an operation method of a power-saving mode for each slave battery monitor device (or, each slave device) in the battery management system with the wireless daisy chain network topology.

### Description of Related Art

To improve the operational efficiency of battery energy storage systems, most of the industrial and vehicular battery energy storage systems adopt a series connection configuration for the battery packs. As a number of batteries connected in series increases, the direct current (DC) voltage across the battery packs also rises. The battery energy storage system should rely on a battery management system (BMS) to monitor and collect information such as the voltage and temperature of each battery in the system, for managing the operation and safety of the battery energy storage. To monitor the parameters of each battery, the battery management system (BMS) in current battery energy storage systems may include multiple monitor devices, and each battery can be paired with one monitor device. Under a wireless daisy chain network topology of these monitor devices, there may be as many of the battery monitor devices as the monitor devices operating simultaneously through the wireless daisy chain network topology.

In some cases, such as during transportation or in warehouses, the battery management system (BMS) needs to use the batteries as the power supply for monitoring purposes, wherein the batteries are not available for charging, and the BMS may excessively consume the battery power without suitable power control. Furthermore, when the BMS is operating and all the slave devices in the wireless daisy chain network topology are functioning simultaneously, the power consumption may increase significantly. Therefore, there is a demand for power-saving purposes in battery management systems (BMS) employing a wireless daisy chain network topology.

### SUMMARY OF THE INVENTION

The present invention provides a technology for a power-saving mode of each slave battery monitor device in a battery management system. By controlling each slave device to enter a power-saving mode, such as a deep sleep mode, the power consumption of the battery management system can be greatly reduced.

According to a first perspective of the present invention, an operation method for a power-saving mode of a battery management system is provided, wherein the master device and a plurality of slave devices of the battery management system are wirelessly connected in series to form a wireless daisy chain network topology. The operation method includes: the master device transmitting a power-saving mode command to one of the plural slave devices; the one of the plural slave devices, forwarding the received power-saving mode command to another one of the plural slave devices according to a predetermined forwarding order, and the one slave devices entering a deep sleep mode based on the power-saving mode command. The operation method further includes: sequentially operating to forward the power-saving mode command by the others slave devices according to the predetermined forwarding order, and to enter the deep sleep mode, until a last-stage slave device in the predetermined forwarding order receives the power-saving mode command and enters the deep sleep mode.

According to a second perspective of the present invention, an operation method for a power-saving mode of a battery management system is provided, wherein a master device and N slave devices of the battery management system are wirelessly connected in series, to form a wireless daisy chain network topology. The operation method includes: the master device transmitting a power-saving mode command to an n-th slave device among the N slave devices, where N is a positive integer and n is a positive integer between 1 and N; the n-th slave device forwarding the received power-saving mode command to an (n+k)−th slave device among the N slave devices according to a predetermined forwarding order, and the n-th slave device entering a deep sleep mode based on the power-saving mode command; and, in the others slave devices, sequentially forwarding the power-saving mode command from one slave device to another slave device according to the predetermined forwarding order, and entering the deep sleep mode of the one slave device, until a last-stage slave device of the N slave devices in the predetermined forwarding order receives the power-saving mode command and enters the deep sleep mode. When one or more of the slave devices in the predetermined forwarding order are in the deep sleep mode, only a power management unit of each of the one or more slave devices operates, and the one or more slave devices exit the deep sleep mode by the power management unit to enter a listening mode within a preset time interval, for detecting and receiving a wake-up message when transmitted from the master device.

According to a third perspective, the present invention provides a battery management system, which includes: a master device and N slave devices wirelessly connected in series, each of the N slave devices including a power management unit, wherein N is a positive integer. The master device and the N slave devices form a wireless daisy chain network topology. The battery management system enters a power-saving mode by: the master device transmitting a power-saving mode command to an n-th slave device among the N slave devices, wherein n is a positive integer between 1 and N; the n-th slave device forwarding the received power-saving mode command to an (n+k)−th slave device among the N slave devices according to a predetermined forwarding order, and entering the deep sleep mode by the n-th slave device based on the power-saving mode command; and in the others slave devices, sequentially forwarding the power-saving mode command from one slave device to another slave device according to the predetermined forwarding order, and entering the deep sleep mode, until a last-stage slave device in the predetermined forwarding order of the one or more slave devices, receives the power-saving mode command and enters the deep sleep mode. When the one or more of the slave devices in the predetermined forwarding order are in the deep sleep mode, only a power management unit of each of the one or more slave devices operates, and the one or more slave devices exit the deep sleep mode to enter a listening mode within a preset time interval by the power management unit, for detecting and receiving a wake-up message when transmitted from the master device.

The objectives, technical details, features, and benefits of the present invention can be better understood with regard to the detailed description of the embodiments below, and with reference to the associated drawings.

### BRIEF DESCRIPTION OF THE DRAWINGS

FIG. 1 schematically illustrates a battery system including a battery management system according to various embodiments of the present invention.

FIG. 2 schematically illustrates an operation of slave battery monitor devices in a power-saving mode, with a downlink data chain and an uplink data chain according to various embodiments of the present invention.

FIG. 3A schematically illustrates multiple connection timetables for various devices in the battery management system according to various embodiments of the present invention.

FIG. 3B schematically illustrates various connection timetables for various devices in the battery management system based on a link profile according to various embodiments of the present invention.

FIG. 4 schematically illustrates a flowchart of an operation procedure for a power-saving mode of the battery management system according to various embodiments of the present invention.

### DESCRIPTION OF THE PREFERRED EMBODIMENTS

The objectives, technical details, features, and effects of the present invention can be better understood with regard to the detailed description of the embodiments below, with reference to the associated drawings. The technical wordings/terms in this specification are based on a customary understanding of the art. In this specification, the interpretations of these wordings/terms are preferentially based on the description or the definition in this specification. Each embodiment of the present invention includes at least one technical feature. To the extent possible, a person having ordinary knowledge in the art may, as needed, select, combine, or modify some or all of the technical features in any one of the embodiments, within the spirit and scope of the present invention.

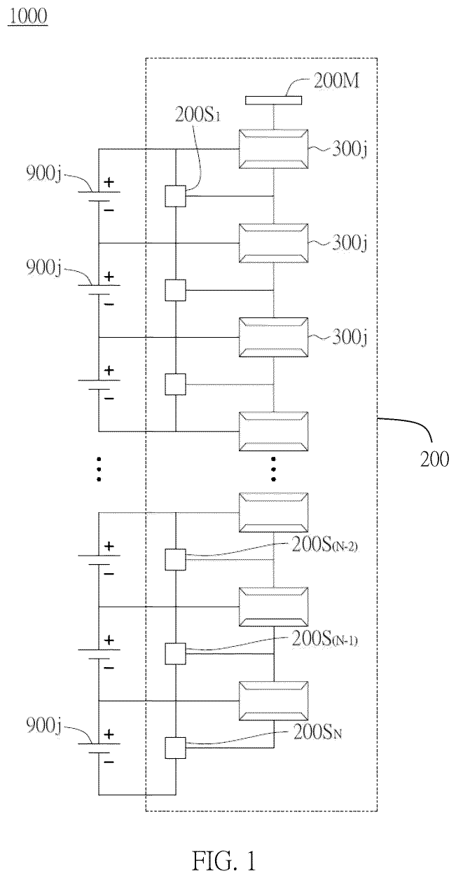

Please refer to FIG. 1, which illustrates a schematic diagram of a battery system 1000 and a battery management system (BMS) 200 according to one embodiment of the present invention. The battery system 1000 includes a plurality of battery cells 900j and the battery management system (BMS) 200. The battery cells 900j are connected in series. During operation of the battery system 1000, it is necessary to monitor the battery cells 900j to ensure that battery parameters such as temperature and voltage are within normal ranges (or, predetermined operational ranges). Therefore, each battery cell 900j (for example, a battery monitor device 200S₁ serving as a first stage, till a battery monitor device 200SN serving as a final stage) is provided with a corresponding battery monitor device, for monitoring purposes.

As shown in FIG. 1, the battery management system (BMS) 200 includes a main control device 200M (also referred to as a master device), a plurality of battery monitor devices (200S₁ to 200SN), and a plurality of communication couplers 300j. The battery monitor devices (200S₁ to 200S_{N}) have a control connection to the main control device 200M, may be referred to as slave devices. Each communication coupler 300j may be an optical communication coupler or a radio frequency (RF) coupler, to be disposed between the main control device 200M and the first-stage battery monitor device 200S₁, or between adjacent battery monitor devices from a first stage battery monitor device 200S₁ to a final stage battery monitor device 200S. The main control device 200M and each of the battery monitor devices (200S₁ to 200S_{N}) respectively communicate pairwise through the communication couplers 300j employing short-range wireless communication (i.e., whisper-type communication), so as to sequentially transmit data, messages, or commands to the battery monitor device 200SN in a downlink data chain, or to sequentially return acknowledgment information from the battery monitor device 200SN in an uplink data chain. Accordingly, the main control device 200M and the battery monitor devices (200S₁ to 200SN) (i.e., the slave devices) together form a wireless daisy chain network topology, where N is a positive integer.

Since the plural battery monitor devices (200S₁ to 200S_{N}) consume the electrical power of the monitored battery cells 900j during storage or transportation to maintain the monitoring function, excessive power consumption may occur and should be avoided when charging function is unavailable in the battery management system (BMS) 200. Accordingly, to ensure that the battery cells 900j managed by the battery management system (BMS) 200 do not excessively discharge under non-charging conditions (for example, during storage or transportation), the present invention provides a power-saving mode technology applicable to each battery monitor device. In one embodiment, a power-saving mode command is sequentially transmitted along the downlink data chain among the battery monitor devices to the plural battery monitor devices (200S₁ to 200S_{N}), for example, the first-stage battery monitor device 200S₁ (the first slave device 200S₁). Each subsequent battery monitor device receiving the power-saving mode command then forwards the power-saving mode command, to let the corresponding battery 900j enter the power-saving mode, including such as a deep sleep mode or a light sleep mode, thereby achieving a reduction in the overall power consumption of the battery management system 200.

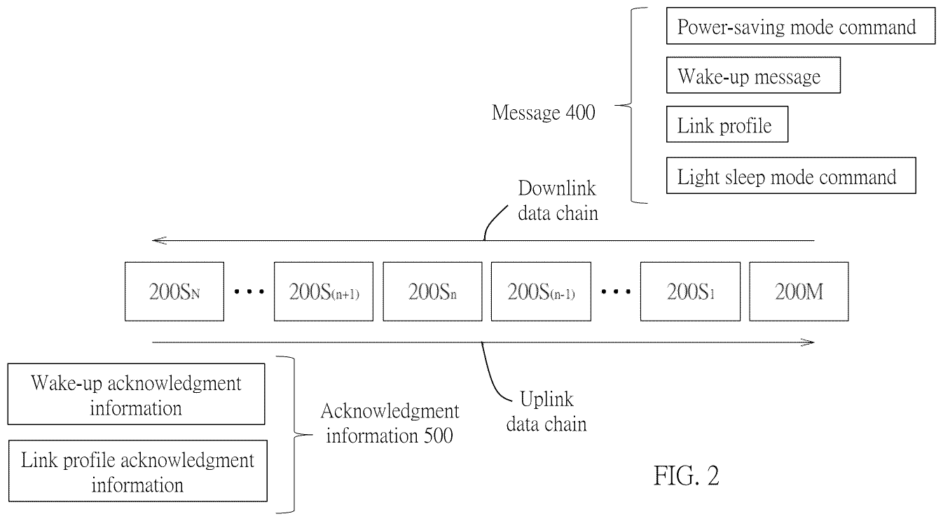

FIG. 2 illustrates a schematic diagram of multiple battery monitor devices (battery monitor devices 200 S₁ to 200S_{N}) operating in a power-saving mode according to several embodiments of the present invention, utilizing both a downlink data chain and an uplink data chain. In an environment where a wireless daisy-chain network topology has been established, during downlink data transmission, a main control device (200M) may transmit a power-saving mode command (for example, embedded within a message 400) to, for example, a first-stage battery monitor device (200S₁). Upon receiving the power-saving mode command, the first-stage battery monitor device (200S₁) then forwards the power-saving mode command to a second-stage battery monitor device (200S₂), and then lets the corresponding battery 900j enter a deep sleep mode. Each subsequent battery monitor device continues to sequentially forward the power-saving mode command and let the corresponding battery 900j enter the deep sleep mode, until the last-stage (or tail-slave) battery monitor device (200S_{N}) receives the power-saving mode command and let the corresponding battery 900j enter the deep sleep mode. In other words, the predetermined forwarding order for transmitting the power-saving mode command to each of the battery monitor devices can be arranged as: the battery monitor device 200S₁, the battery monitor device 200S₂, and so on, until the battery monitor device 200S_{N}.

In some embodiments, when not all the battery monitor devices within the wireless daisy-chain network topology are required to enter the deep sleep mode, one or more of the specific battery monitor devices in the battery management system 200 with the wireless daisy chain network topology may be designated to enter the deep sleep mode. For example, there could only the battery monitor devices 200S₁, 200S₃, and 200S₇ are required to enter the deep sleep mode, these devices may sequentially receive and forward the power-saving mode command and enter the deep sleep mode according to the predetermined forwarding order (for instance, the predetermined forwarding order prioritizes the battery monitor device 200S₁, the battery monitor device 200S₃, and the battery monitor device 200S₇). The process continues until the last-stage battery monitor device in the predetermined forwarding order (e.g., battery monitor device 200S₇) receives the power-saving mode command and enters the deep sleep mode.

When all of the battery monitor devices are in the deep sleep mode, only the power management unit (PMU) disposed within each battery monitor device remains operational, while other components, such as the controller or signal transmission/reception units (for example, the multiple communication couplers 300j shown in FIG. 1) are powered off. The power management unit (PMU) described herein can be referred to as a small internal power control module set within the battery monitor device, rather than a system or unit used for managing the overall battery power. Furthermore, while in the deep sleep mode, each battery monitor device periodically exits the deep sleep mode within a preset time interval and enters a listening mode, during which its power management unit (PMU) becomes active to detect and receive if a wake-up message transmitted from the main control device (200M). In some embodiments, the preset time interval is 900 ms. If no wake-up message is received within 100 ms during the listening mode, the device re-enters the deep sleep mode. Specifically, when in the listening mode, if a battery monitor device activates its corresponding communication coupler (300j) near the receiving antenna of the previous stage and receives the wake-up message from the main control device (200M), the device exits the deep sleep mode and enters a working mode. Simultaneously, the battery monitor device forwards the wake-up message through its corresponding communication coupler (300j) via the transmitting antenna toward the next stage, thereby awakening the battery monitor device at the subsequent stage. Each of the battery monitor devices sequentially forwards the received wake-up message to the next stage, until the last-stage battery monitor device (200SN) receives the wake-up message and exits the deep sleep mode.

In some embodiments, when not all the battery monitor devices within the wireless daisy-chain network topology are in the deep sleep mode, one or more specific battery monitor devices currently in the deep sleep mode may likewise be designated to exit the deep sleep mode. For example, when only battery monitor devices 200S₁, 200S₃, and 200S₇ are required to exit the deep sleep mode, these devices may receive and forward the wake-up message according to a predetermined forwarding order (for instance, the predetermined forwarding order prioritizes the battery monitor device 200S1, the battery monitor device 200S3, and the battery monitor device 200S7), and sequentially exit the deep sleep mode. The process continues until the last-stage battery monitor device in the predetermined forwarding order (e.g., the battery monitor device 200S7) receives the wake-up message and exits the deep sleep mode.

After the battery monitor device 200SN exits the deep sleep mode, acknowledgment information (for example, embedded within acknowledgment information 500) may be transmitted to the main control device 200M via the uplink data chain. Upon receiving the acknowledgment information, the main control device 200M can determine that all battery monitor devices within the battery management system (BMS) have exited the deep sleep mode and entered the working mode. In some embodiments, when the main control device 200M does not receive the acknowledgment information within a specified period of time after transmitting the wake-up message, it may retransmit the wake-up message repeatedly until the acknowledgment information is received within the specified time period after the corresponding wake-up message.

In some embodiments, the wake-up message transmitted from the main control device 200M may include a total number of battery monitor devices within the wireless daisy-chain network topology, together with an incremental counter (wherein the counter is initialized to “1”, indicating that the battery monitor device 200S₁ is being awakened: {NumOfSlaves, SlaveID} ). When a battery monitor device within the wireless daisy-chain network topology receives the wake-up message of the form {NumOfSlaves=N, SlaveID=N} , it indicates that the device is the last-stage (tail device), namely the battery monitor device 200SN. In this manner, the battery monitor device 200SN can, as described above, transmit an acknowledgment information (or, acknowledge message) back to the main control device 200M through the uplink data chain, thereby allowing the main control device 200M to confirm that all battery monitor devices have exited the deep sleep mode, successfully established network connectivity, and entered the working mode.

In some embodiments, when a battery monitor device receives a power-saving mode command, it may store operating information, such as communication settings into its power management unit (PMU), set a preset time interval, and power off the power supply to all components except the power management unit, thereby entering the deep sleep mode. When the power management unit of the battery monitor device subsequently activates the device's control unit in response to the received wake-up message, the control unit may load the operating information, such as the communication settings stored in the power management unit, to allow the battery monitor device to directly enter the working mode, i.e., resume the operational state before entering the deep sleep mode, without requiring a system reset.

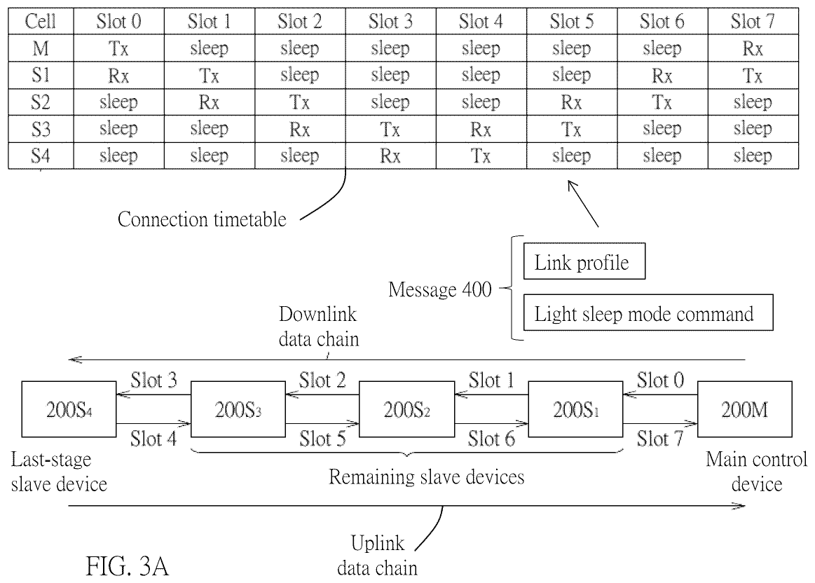

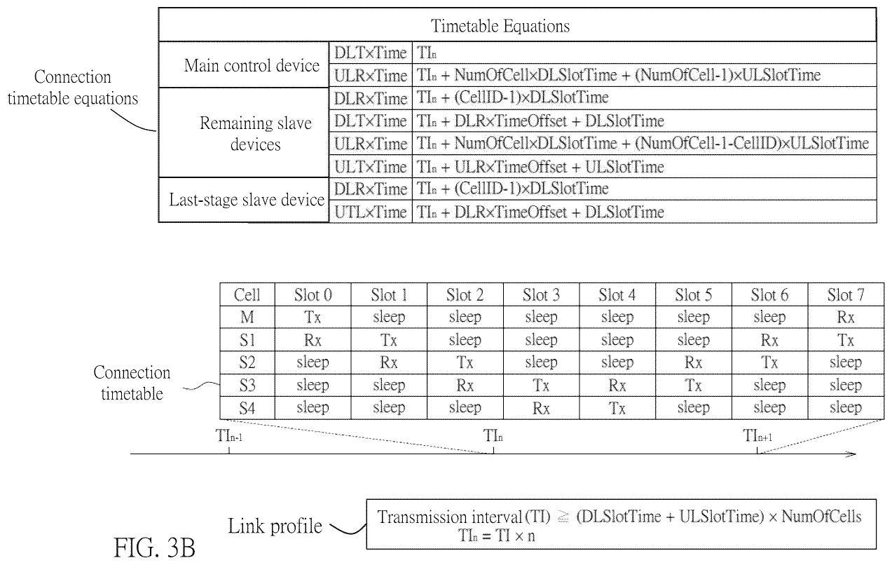

When the battery management system (BMS) is operating, and all slave devices within the wireless daisy-chain network topology are simultaneously active (for example, in the working mode), the overall power consumption increases. The present invention further provides a light sleep mode (or, sleep mode technology), enabling each slave device to selectively power down certain components during operation, thereby achieving power-saving purposes. The following description, together with FIGS. 3A and 3B, provide detailed explanations of these features.

FIGS. 3A and 3B respectively illustrate schematic diagrams of a connection timetable of each device (including the main control device 200M and battery monitor devices 200S₁ to 200S₄) within the battery management system 200 according to several embodiments of the present invention, and a schematic diagram showing how each device derives its respective connection timetable based on the link profile (link configuration). In this embodiment, four slave devices (battery monitor devices 200S₁ to 200S₄) are illustrated for illustration; however, the present invention is not limited thereto. Referring to FIG. 3A, as discussed above, when all the slave devices (battery monitor devices 200S₁ to 200S₄) are in the working mode, the main control device 200M may transmit a link profile (link configuration), for example, embedded within message 400, through the downlink data chain to the slave devices (such as battery monitor device 200S₁ first). The link profile may then be sequentially forwarded to the subsequent battery monitor devices, until to the battery monitor device 200S₄. After the battery monitor device 200S₄ receives the link profile, it may return the acknowledgment information through the uplink data chain to the main control device 200M, thereby confirming that all slave devices have successfully received the link profile. The main control device 200M and each slave device (battery monitor devices 200S₁ to 200S₄) may then derive their respective connection timetables based on the received link profile. The connection timetable includes a series of time slots corresponding to different operational intervals—for example, Slots 0 to 3 correspond to the downlink data chain, and the Slots 4 to 7 correspond to the uplink data chain. The main control device and each slave device perform their respective operations according to the generated connection timetable within their assigned time slots. For instance, as shown in the connection timetable, the battery monitor device 200S₂ activates its communication interface for receiving messages (e.g., the receiving antenna used for the downlink data chain) during the Slot 1, activates its communication interface for transmitting messages (e.g., the transmitting antenna unit for the downlink data chain) during the Slot 2, activates its communication interface for receiving messages (e.g., the receiving antenna for the uplink data chain) during the Slot 5, and activates its communication interface for transmitting messages (e.g., the transmitting antenna unit for the uplink data chain) during the Slot 6. These communication interfaces correspond to the communication couplers 300j illustrated in FIG. 1. During other time slots, the battery monitor device 200S₂ may enter the light sleep mode, for example, by disabling the aforementioned communication interfaces to reduce power consumption.

Referring now to FIG. 3B, which illustrates how each device derives its corresponding connection timetable based on the link profile (link configuration). The link profile includes parameters such as the Transmission Interval (TI), the Downlink Slot Time (DLSlotTime), the Uplink Slot Time (ULSlotTime), and the Number of Devices (NumOfCells). The Transmission Interval (TI) has an equation:

$$TI \geq ( DKSlotTime + ULSlotTime ) \times NumOfCells$$

Furthermore, TIn represents n transmission intervals, where TIn=TI×n. Based on the link profile, all devices (including the main control device 200M) can derive their respective connection timetables to determine the timing for transmission (TX) and reception (RX) operations. The transmission (TX) operations can be divided into Downlink Transmission Time (DL-TX) and Uplink Transmission Time (UL-TX), while the reception (RX) operations can be divided into Downlink Reception Time (DL-RX) and Uplink Reception Time (UL-RX). For the main control device (200M), only DL-TX and UL-RX times need to be derived. For the last-stage battery monitor device (200S₄), only DL-RX and UL-TX need to be derived. For the remaining slave devices (for example, the battery monitor devices 200S₁ to 200S₃), all four timing parameters—DL-TX, UL-TX, DL-RX, and UL-RX—must be derived, as illustrated in the connection time equations table shown in FIG. 3B.

After each device has derived its respective connection timetable, when the main control device (200M) transmits a light sleep mode command (SleepMode Command or SleeMode Command), all slave devices (e.g., the battery monitor devices 200S₁ to 200S₄) enter the light sleep mode at their corresponding designated times specified by the light sleep mode command. As explained above and illustrated in the connection timetables of FIGS. 3A and 3B, each device operates according to its respective connection timetable, exiting the light sleep mode during the corresponding time slots to transmit and receive messages, and then automatically re-entering the light sleep mode according to the next assigned time slot. In this manner, when active operation is not required, each device (including the main control device and all battery monitor devices) can enter the light sleep mode, which consumes less power, thereby reducing the overall power consumption of the battery management system (BMS).

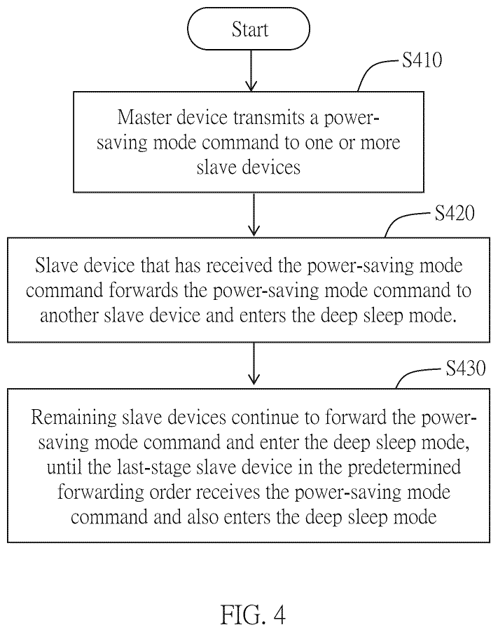

In one embodiment, FIG. 4 illustrates a flowchart of an operational procedure for the power-saving mode of a battery management system (BMS) (for example, the battery management system 200 shown in FIG. 1) according to several embodiments of the present invention. In Step S410, a master device, such as the main control device 200M shown in FIGS. 1 to 3A, transmits a power-saving mode command to one or more slave devices (for example, the battery monitor device 200S₁ shown in FIGS. 1 to 3A) through the downlink data chain (as illustrated in FIG. 2). In the Step S420, the slave device that has received the power-saving mode command forwards the power-saving mode command to the next slave device (for example, the battery monitor device 200Sₙ₊1 shown in FIG. 2, or other battery monitor devices defined in the predetermined forwarding order) and then enters the deep sleep mode. In the Step S430, the remaining slave devices continue to forward the power-saving mode command and enter the deep sleep mode, until the last-stage slave device in the predetermined forwarding order (for example, the battery monitor device 200S_{N} shown in FIGS. 1 and 2, or the battery monitor device 200S₄ shown in FIG. 3A) receives the power-saving mode command and also enters the deep sleep mode.

In some embodiments, when a slave device is in the deep sleep mode, only the device's power management unit (PMU) remains operational. The slave device operates by its power management unit to exit the deep sleep mode within a preset time interval and enters a listening mode for detecting and receiving the wake-up message when transmitted from the master device. Or, the slave device operates by its power management unit, to periodically exit the deep sleep mode within each of the preset time interval and to enter the listening mode for detecting and receiving the wake-up message.

In some embodiments, the preset time interval is 900 ms. When no wake-up message is received within 100 ms during the listening mode, the device re-enters the deep sleep mode.

In some embodiments, while in the deep sleep mode, a slave device receives the wake-up message, and the power management unit (PMU) of the slave device activates the device's control unit to exit the deep sleep mode and forwards the wake-up message to other slave devices. This forwarding process continues until, for example, the last-stage slave device receives the wake-up message, exits the deep sleep mode, and transmits the acknowledgment information back to the master device (for wake-up acknowledgment), thereby ensuring that all slave devices previously in the deep sleep mode have exited the deep sleep mode.

In some embodiments, when a slave device receives a power-saving mode command, it stores operating information into its power management unit (PMU), sets a preset time interval, and turns off the power supply to all components except the power management unit, thereby entering the deep sleep mode.

In some embodiments, when the power management unit (PMU) of a slave device activates the device's control unit in response to the wake-up message, the control unit loads the operating information stored in the power management unit, to allow the slave device to directly enter the working mode. The operating information includes communication settings.

In some embodiments, when all slave devices are in the working mode, the slave devices receive a link profile (link configuration) transmitted by the master device. Based on the link profile, the master device and each slave device derive their respective connection timetables. The connection timetable of the master device includes the downlink transmission time and the uplink reception time. The connection timetable of the last-stage slave device includes the downlink reception time and the uplink transmission time. The connection timetables of the other slave devices include the downlink transmission time, downlink reception time, uplink reception time, and uplink transmission time.

In some embodiments, when a slave device receives a light sleep mode command transmitted by the master device, it enters the light sleep mode at the designated time specified in the light sleep mode command. While the slave device is in the light sleep mode, its communication interface is turned off. During the light sleep mode, the slave device, according to its connection timetable, activates the communication interface to transmit or receive messages, and then deactivates the communication interface to re-enter the light sleep mode. When operating in the light sleep mode, the control unit and memory of the slave device operate in the low-power consumption mode to minimize power consumption.

Although the present disclosure has been described with reference to certain embodiments and illustrative examples, such embodiments and examples are provided solely for purposes of clarity and understanding. The specific components, configurations, numerical values, and names described herein are exemplary in nature and are not intended to limit the scope of the present disclosure in any manner. Variations, modifications, substitutions, or equivalent arrangements may be made without departing from the spirit or scope of the present disclosure. In addition, certain reference numerals and/or letters may be repeated among different embodiments or examples for illustrative purpose. Such repetition is not intended to imply that the embodiments and/or configurations necessarily share any structural, functional, or operational relationship.

What is claimed is:

1. An operation method for a battery management system in a power-saving mode, wherein a master device and a plurality of slave devices of the battery management system, form a wireless daisy chain network topology, and the operation method includes:
the master device transmitting a power-saving mode command to one of the slave devices;
the one slave device forwarding the received power-saving mode command to another slave device according to a predetermined forwarding order, and entering a deep sleep mode based on the power-saving mode command; and
the another slave device continuing to forward the power-saving mode command to yet another slave device according to the predetermined forwarding order, and to enter the deep sleep mode, such that each slave device in the predetermined forwarding order, operates sequentially to forward the power-saving mode command and to enter the deep sleep mode, until a last-stage slave device in the predetermined forwarding order, receives the power-saving mode command and enters the deep sleep mode.

2. An operation method for a battery management system in a power-saving mode, wherein a master device and N slave devices of the battery management system form a wireless daisy chain network topology, and the operation method includes:
the master device transmitting a power-saving mode command to an n-th slave device among the N slave devices, wherein N is a positive integer and n is a positive integer between 1 and N;
the n-th slave device forwarding the received power-saving mode command to an (n+k)−th slave device among the N slave devices according to a predetermined forwarding order, wherein k is a positive integer between 1 and N−1, and the n-th slave device entering a deep sleep mode according to the power-saving mode command; and
in the others slave devices, operating sequentially to forward the power-saving mode command from one slave device to another slave device according to the predetermined forwarding order, and to enter the deep sleep mode of the one slave device, until a last-stage slave device in the predetermined forwarding order receives the power-saving mode command and enters the deep sleep mode;
wherein, when the one or more slave devices in the predetermined forwarding order, are in the deep sleep mode, only a power management unit of each of the one or more slave devices remains in operation, and wherein, the power management unit of the one or more slave devices exits the deep sleep mode within a preset time interval, to enter a listening mode for detecting and receiving a wake-up message when transmitted from the master device.

3. The operation method according to claim 2, wherein the preset time interval is 900 ms; and, when no wake-up message is detected within 100 ms during the listening mode, the corresponding slave device re-enters the deep sleep mode.

4. The operation method according to claim 2, wherein, when the one or more slave devices in the deep sleep mode receive the wake-up message, the power management unit of each of the one or more slave devices activates a control unit of the corresponding slave device, to exit the deep sleep mode, and to forward the wake-up message to an (n+k)−th slave device according to the predetermined forwarding order, such that each slave device in the predetermined forwarding order, operates sequentially to exit the deep sleep mode and to forward the wake-up message, until the last-stage slave device in the predetermined forwarding order receives the wake-up message, exits the deep sleep mode, and returns the wake-up message to the master device, thereby enabling all the one or more slave devices in the deep sleep mode to exit the deep sleep mode.

5. The operation method according to claim 4, wherein when the one or more slave devices in the predetermined forwarding order receive the power-saving mode command, the one or more slave devices store operational information in the power management unit, set the preset time interval, and deactivate power supplied to components except for the power management unit, to enter the deep sleep mode.

6. The operation method according to claim 5, wherein, when the power management unit of each of the one or more slave devices in the deep sleep mode activates the control unit of the corresponding slave device according to the wake-up message, the control unit loads the operational information stored in the power management unit to make the corresponding slave device to directly enter a working mode, wherein the operational information includes a communication setting.

7. The operation method according to claim 6, wherein, when all the N slave devices are in the working mode, each of the N slave devices receives a link profile transmitted from the master device, wherein the master device and each of the N slave devices respectively obtain connection timetables according to the link profile;
wherein the connection timetable of the master device includes a downlink transmission time and an uplink reception time; and
wherein the connection timetable of the N-th slave device serving as the last-stage slave device in the predetermined forwarding order, includes a downlink reception time and an uplink transmission time; and the connection timetable of each of the other slave devices includes a downlink transmission time, a downlink reception time, an uplink reception time, and an uplink transmission time.

8. The operation method according to claim 7, wherein, when each of the N slave devices receives a light sleep mode command transmitted from the master device, each of the N slave devices enters a light sleep mode according to a designated time included in the light sleep mode command;
wherein, when each of the N slave devices is in the light sleep mode, deactivating a communication interface of each of the N slave devices; or, activating the communication interface according to the connection timetable of each of the N slave devices for transmitting or receiving a message, and deactivating the communication interface to re-enter the light sleep mode; and
wherein, the control unit and a memory of each of the N slave devices in the light sleep mode, enter a low-power consumption mode.

9. A battery management system, including:
a master device; and
N slave devices connected in series wirelessly, each of the N slave devices including a power management unit, wherein N is a positive integer;
wherein the master device and the N slave devices form a wireless daisy chain network topology, and the battery management system enters a power-saving mode by:
the master device transmitting a power-saving mode command to an n-th slave device among the N slave devices, wherein n is a positive integer between 1 and N;
the n-th slave device forwarding the received power-saving mode command to an (n+k)−th slave device among the N slave devices according to a predetermined forwarding order, wherein k is a positive integer between 1 and N−1, and the n-th slave device entering a deep sleep mode according to the power-saving mode command;
in the others slave devices, sequentially forwarding the power-saving mode command from one slave device to another slave device according to the predetermined forwarding order, and entering the deep sleep mode of the one slave device, until a last-stage slave device in the predetermined forwarding order receives the power-saving mode command and enters the deep sleep mode; and
wherein, when one or more of the slave devices in the predetermined forwarding order are in the deep sleep mode, only the power management unit of each of the one or more slave devices remains in operation, and wherein the power management unit of each of the one or more slave devices exits the deep sleep mode within a preset time interval to enter a listening mode, for detecting and receiving a wake-up message when transmitted from the master device.

10. The battery management system according to claim 9, wherein the preset time interval is 900 ms; and, when no wake-up message is detected within 100 ms during the listening mode, the corresponding slave device re-enters the deep sleep mode.

11. The battery management system according to claim 9, wherein each of the N slave devices further includes a control unit; and
wherein, when the one or more slave devices in the deep sleep mode receive the wake-up message, the power management unit of each of the one or more slave devices activates the control unit for exiting the deep sleep mode, and forwards the wake-up message to an (n+k)−th slave device according to the predetermined forwarding order, until the last-stage slave device in the predetermined forwarding order receives the wake-up message, exits the deep sleep mode, and returns a wake-up acknowledgment to the master device, thereby enabling all the one or more slave devices in the deep sleep mode to exit the deep sleep mode.

12. The battery management system according to claim 11, wherein, when the one or more slave devices in the predetermined forwarding order receive the power-saving mode command, the one or more slave devices store operation information in the power management unit, set a preset time interval, and deactivate power supplied to components except for the power management unit to enter the deep sleep mode.

13. The battery management system according to claim 12, wherein, when the power management unit of each of the one or more slave devices in the predetermined forwarding order activates a control unit of the one or more slave devices based on the wake-up message, the control unit loads the operation information stored in the power management unit to make the one or more slave devices directly enter a working mode, wherein the operation information includes a communication setting.

14. The battery management system according to claim 13, wherein, when all the N slave devices are in the working mode, each of the N slave devices receives a link profile transmitted from the master device, wherein the master device and each of the N slave devices obtain connection timetables according to the link profile, respectively;
wherein the connection timetable of the master device includes a downlink transmission time and an uplink reception time;
wherein the connection timetable of the N-th slave device serving as the last-stage slave device in the predetermined forwarding order, includes a downlink reception time and an uplink transmission time, and wherein the connection timetable of each of the other slave devices includes a downlink transmission time, a downlink reception time, an uplink reception time, and an uplink transmission time.

15. The battery management system according to claim 14, wherein, when each of the N slave devices receives a light sleep mode command transmitted from the master device, each of the N slave devices enters a light sleep mode according to a designated time included in the light sleep mode command;
wherein, when each of the N slave devices is in the light sleep mode, deactivating a communication interface of each of the N slave devices; activating the communication interface of each of the N slave devices according to the connection timetable of each of the N slave devices for transmitting or receiving a message, and deactivating the communication interface to re-enter the light sleep mode; and, the control unit and a memory of each of the N slave devices entering a low-power consumption mode.
